(19) United States
(12) Patent Application Publication
(10) Pub. No.: US 2006/0162753 A1
(43) Pub. Date: Jul. 27, 2006

(54) Turnaround device

(76) Inventors: Clare Grana, Reston, VA (US); Brian Sweeney, Brewster, MA (US)

Correspondence Address: JENKENS & GILCHRIST, 1401 MCKINNEY, SUITE 2600, HOUSTON, TX, 77010, US

(21) Appl. No.: 11/050,856

(22) Filed: Jan. 27, 2005

(51) Int. Cl. A61H 3/00

(52) U.S. Cl. 135/67

(57) ABSTRACT

Modified walkers for use by persons having physical disabilities are provided. The modified walkers permit a person using the walker to more easily turn from one position to another.

### FIELD OF THE INVENTION

The present invention relates to a modified walker for use by persons having physical disabilities. More specifically, the inventive walker relates to a device that permits a person using a walker to more easily turn from one direction to another without having to lift the walker.

### DESCRIPTION OF RELATED ART

Walkers are commercially available for those physically handicapped persons having muscle weakness and/or lack of full muscle control that seriously affect normal walking motions and bodily balance. Such walkers aid a person that may be frail or who may have difficulty walking freely to move from place to place. For each one or more steps the user takes, the walker is lifted from the floor and repositioned on the walking surface a short distance in the direction the user is moving and in advance of taking additional steps. One type of walker in use today has a generally rectangular, tubular frame. The walker has four legs and is open at the rear. In some variations of this walker design, all four legs terminate in caps or buttons that slide along or otherwise engage the floor or other walking surface. Such a walker is described in U.S. Pat. No. 4,922,940.

In another design variation, the two front walker legs are provided with wheels while the floor engaging ends of the rear legs terminate in a cap or button that slides along the floor or other surface as the user moves with the walker. In another approach, wheels have been provided on the rear walker legs as well as on the front. Such four-wheel walkers may also include a variety of braking systems that either act upon one or more of the walker wheels or rely upon an appendage to contact and drag along the floor or other walking surface. Examples of full-wheeled walkers that also incorporate a braking system include those described in U.S. Pat. Nos. 5,020,560 and 6,068,273.

Walkers known in the art can be difficult to maneuver, particularly when a user wishes to turn in place. For example, when a person of limited mobility pulls himself up from a bed to a standing position using a walker, and then wishes to turn to sit in a chair, such as a wheel chair, repositioning can be difficult if not impossible depending on the strength and agility of the person. Likewise, it can be difficult for a person using a walker to turnaround to face the opposite direction. What is needed is a device that facilitates and, in some cases makes possible, movement of persons of such limited ability to walk, stand and turn.

### SUMMARY OF THE INVENTION

The invention satisfies the need and avoids the drawbacks of the prior art by providing a device that permits small movements by persons, particularly allowing a person lacking mobility to turn 45°, 90° or even 180°. In one embodiment, the walker of this invention includes a generally rectangular three-sided frame that is open at the back and has a plurality of downwardly extending legs.

One aspect of the present invention is directed to a turnaround device that includes a walker frame and a rotating structure for turning the walker frame from a first position to a second position without a person having to lift the walker frame between the first position and the second position. In one embodiment, the walker frame has a left side member and a right side member that each include downwardly extending front and rear legs. The side members may be held rigidly spaced apart by at least one front frame member.

In certain aspects of the present invention the rotating structure for turning the walker frame may be a supporting device. The supporting device may include at least three wheels that contact a walking surface and a rotatable platform supported by the wheels. In some embodiments, the supporting device may include at least two braking devices. In certain embodiments, each braking device may engage a single wheel, so that the rotatable platform may be prevented from rotating. Other braking devices known in the art that may prevent the platform from rotating are known in the art, such as appendages that contact and drag along the walking surface, among others. The supporting device may also have securing structures for securing the walker frame to the supporting device, in certain aspects of the present invention. In some embodiments, the securing structures may be adjusted to reversibly release the walker frame. The walker frame may be permanently affixed to the supporting device in certain embodiments.

In some aspects, the supporting device may include a stationary base that may, in certain embodiments, contact a walking surface, a plurality of rolling devices, such as bearings, among other rotational structures, and a rotatable platform that is above the stationary base. In certain embodiments, the supporting device may have an inset member, permitting the rotatable platform to be inset in the device with the rotatable platform being circumscribed by the inset member. The base and the platform may have coaxial vertical, central axes, and the rotatable platform may revolve about its vertical, central axis. In certain aspects, at least a portion of the rolling devices contact the base and the platform. In certain embodiments, the supporting device may have at least one braking device that may prevent the rotatable platform from rotating, such braking devices are known in the art.

Certain aspects of the present invention are directed to a turnaround device that includes a supporting device, a pole, and a handle for a person to hold onto the pole. The supporting device may include a stationary base that may, in certain embodiments, contact a walking surface, and a rotatable platform that is above the stationary base in certain embodiments. In certain aspects, the supporting device may have an inset member, permitting the rotatable platform to be inset in the device with the rotatable platform being circumscribed by the inset member. The supporting device, in some embodiments, includes the base and the rotatable platform having coaxial vertical, central axes, and the rotatable platform includes an opening therethrough. The opening may have a vertical, central axis that is coaxial with that of the vertical, central axis of the rotatable platform in certain embodiments. The pole has a top end and a bottom end, and the bottom end may be affixed to the stationary base and extend up through the opening in the rotatable platform. The pole may have a height of between about three and about five feet in certain embodiments. In some embodiments, the pole may have a height of between about three and about four feet. The pole may have a height such that persons using the device need not lean over to reach the handle, and need not lift their arms above chest level to turn themselves on the rotatable platform. In certain embodiments, the height of the pole itself or the height of the handle on the pole may be adjustable, so that persons using the device may adjust the height so that it is comfortable to hold. In some embodiments, the vertical, central axis of the pole is coaxial with that of the vertical, central axis of the stationary base, and the rotatable platform. In some embodiments the supporting device may include a plurality of rolling devices, such as bearings, among other rotational structures, that contact both the stationary base and the rotatable platform. Furthermore, in certain embodiments, the turnaround device may have at least one braking device that may prevent the rotatable platform from rotating, such braking devices are known in the art.

Some aspects of the present invention are directed to a turnaround device that may include (a) a walker frame having a left side member and/or a right side member, the left and right side members each including downwardly extending front and rear legs, the side members may be held rigidly spaced apart by at least one front frame member, wherein each front leg is supported by a wheel; and (b) at least one front wheel braking device, wherein each front wheel braking device may engage a single front wheel. In some embodiments, the turnaround device has a wheel supporting each rear leg. The walker may include at least one rear wheel braking device, wherein each rear wheel braking device may engage a single rear wheel in certain aspects of the present invention. In certain embodiments, the turnaround device may include two rear wheel braking devices that may be engaged simultaneously.

Some aspects of the invention are directed to a turnaround device that may have a walker frame and a rotating structure. The rotating structure may include a supporting device, which may have a stationary base, a plurality of rolling devices, and a rotatable platform. In some embodiments, the rotatable platform may be inset into the stationary base that may, in certain embodiments, contact a walking surface. In certain embodiments, the supporting device may have at least one braking device. The top of the supporting device (e.g., rotatable platform) may secure the walker frame to the supporting device, as described above. The stationary base may have a plurality of poles extending up perpendicular or substantially perpendicular to the base. Each pole may have a handle attached to it. In certain embodiments, the handle may be releasably adjusted to extend from the pole or fold down to be parallel with the longitudinal axis of the pole. Persons using the turnaround device may step onto the rotatable platform between two poles, then grasping the handles of the poles turn themselves around. Subsequently a person can step down from the turnaround device between two poles. Alternatively, the turnaround device may be mechanized using a motor or other power generating device to rotate the person on the platform. In certain embodiments, the stationary base may be supported by a plurality of wheels that allow the turnaround device to be easily moved from place to place. As persons step onto the device, their weight pushing down may cause a braking system to engage the wheels that support the stationary base.

Certain aspects of the invention are directed to a turnaround device that has a walker frame (as described above), and a supporting device. The walker may be permanently affixed to the supporting device or releasably attached to it. The supporting device can be of a lazy Susan type, which may have a stationary base, a plurality of rolling devices, and a rotatable platform. In some embodiments the supporting device may include a plurality of rolling devices, such as bearings or wheels, among other rotational structures, that contact both the stationary base and the rotatable platform. In some embodiments, the rotatable platform may be inset into the stationary base. The rotatable platform may have an axle or axis about which the platform may rotate. Furthermore, in certain embodiments, the turnaround device may have at least one braking device that may prevent the rotatable platform from rotating, such braking devices are known in the art. In certain embodiments, the turnaround device can be mechanized, and may be capable of battery operation or operation using an electrical cord that is plugged into a power source. The turnaround device may have one or more directional switches on the walker that are easily accessible to the person using it.

Certain aspects of the present invention are directed to a turnaround device comprising, a walker frame having at least one downwardly extending leg; and a rotating structure for turning the walker frame from a first position to a second position, without a person having to lift the walker frame between the first position and the second position. In certain embodiments, the walker frame may have three downwardly extending legs.

### BRIEF DESCRIPTION OF THE DRAWINGS

FIG. 1 is a perspective view of one embodiment of the present invention.

FIG. 2 is a perspective view of another embodiment of the present invention.

FIG. 3a is a perspective view of yet another embodiment of the present invention.

FIG. 3b is a perspective view of one supporting device.

FIG. 3c is a cross-section of the supporting device of FIG. 3b.

FIG. 4 is a perspective view of still another embodiment of the present invention.

FIG. 5 is a perspective view of another embodiment of the present invention.

FIG. 6a is a perspective view of another embodiment of the present invention.

FIG. 6b is a cross-section of the supporting device of FIG. 6a.

FIG. 7 is a perspective view of another embodiment of the present invention.

### DETAILED DESCRIPTION OF THE PREFERRED EMBODIMENTS

Other objects and advantages of this invention will become evident from a study of the following description and accompanying drawings.

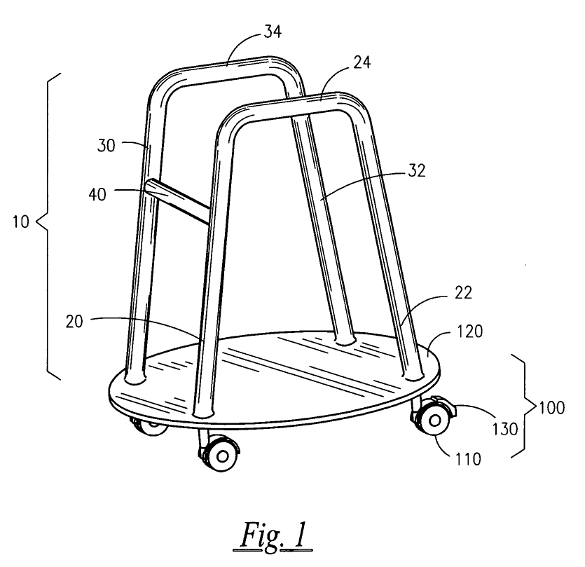

FIG. 1 depicts one embodiment of the present invention. The figure depicts a turnaround device having a walker frame 10. FIG. 1 illustrates walker frame 10 with a left side member 20, 22, 24 and a right side member 30, 32, 34. The left and right side members each include a downwardly extending front leg 20, 30 and a downwardly extending rear leg 22, 32. The front and rear legs of each side member are connected through a frame member 24, 34. It is understood that every described aspect of the invention may be modified to include either a right or left side member and that the legs may be vertical, essentially vertical, or set at various angles. In the walker frame, the side members may be held rigidly spaced apart by at least one front frame member 40. A person is meant to step into the walker frame 10 from the back between the rear legs 22, 32. Certain other walker frames known in the art may be used in combination with the present invention. For example, walkers having a tricycle type configuration having three downwardly extending legs, one leg in front and two legs to the side, may be employed. Also, walkers having more than four downwardly extending legs may be used, among others. In this embodiment, the turnaround device has a rotating structure for turning the walker frame 10 from a first position to a second position without a person having to lift the walker frame 10 between the first position and the second position. The rotating structure for turning the walker may include a supporting device 100 having four wheels 110 and a rotatable platform 120. In some embodiments, the supporting device 100 includes three or more wheels. The supporting device includes at least two braking devices 130. Each braking device 130 may engage a single wheel 110. In one aspect, the braking devices 130 may be engaged while a person steps onto or off of the rotatable platform 120. A variety of braking devices 130 that may be used in the present invention are known in the art. The walker frame 10 may be permanently affixed to the rotatable platform as illustrated in FIG. 1. In other embodiments, the frame 10 may be optionally released and removed from the rotatable platform after use, allowing the walker frame 10 to be used as a walker known in the art. A person using the turnaround device may step onto the rotatable platform 120 from the back of the walker frame 10, and a helper may then rotate the platform 120, so that the person on the device is facing in the desired direction. Alternatively, the turnaround device may be mechanized to rotate the person on the platform 120. The person may then step back off the platform 120 or sit down in a chair, wheelchair, or other weight-bearing device. The braking devices 130 may be engaged, while a person steps onto or off of the rotatable platform 120.

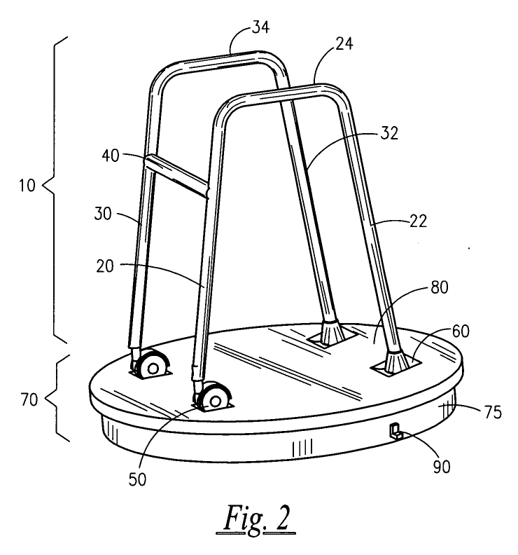

FIG. 2 depicts another embodiment of the turnaround device of the present invention. As illustrated, walker frame 10 includes a left side member 20, 22, 24 and a right side member 30, 32, 34. The left and right side members each include a downwardly extending front leg 20, 30 and a downwardly extending rear leg 22, 32. The front and rear leg of each side member are connected through a frame member 24, 34. In the walker frame, the side members are held rigidly spaced apart by at least one front frame member 40. Certain other walkers that would be apparent to those of skill in the art may be used in the present invention. As shown in FIG. 2, each of legs has a cap 50 affixed to the bottom end of each leg, and the frame is not collapsible. Of course, the walker frame 10 may be, for example, constructed such that it may be collapsed for easy storage, and walker frames having two or more wheels supporting legs of the walker frame may be employed. The turnaround device depicted in FIG. 2 has a rotating structure for turning the walker frame from a first position to a second position without a person having to lift the walker frame between the first position and the second position. The rotating structure depicted in FIG. 2 includes a supporting device 70, which has a stationary base 75, that may, in certain embodiments, contact a walking surface, a plurality of rolling devices, such as bearings, and a rotatable platform 80. The base 75 and the platform 80 may have coaxial vertical, central axes, and the rotatable platform 80 may rotate about its vertical central axis. In certain aspects, at least a portion of the rolling devices contact the base and the platform. The rolling devices may be bearings or wheels, in some embodiments. In certain embodiments, the supporting device may have at least one braking device 90. The supporting device 70 may be constructed as a lazy Susan type assembly, as is known in the art. The top of the supporting device 70 (e.g., rotatable platform 80) may secure the walker frame 10 to the supporting device 70. In some embodiments, the device may include wells 60 on the top of the rotatable platform 80 that receive the wheels or caps 50 of the frame 10. The wheels or caps 50 may be secured by a variety of structures known in the art, such as clamps. In some embodiments the structure employed to attach walker frame 10 to the supporting device 70 may be adjusted to releasably attach walker frame 10, in others the frame 10 may be permanently affixed to the supporting device 70. A person using the turnaround device may step onto the rotatable platform 80, and a helper may then rotate the platform 80, so that the person on the device may be revolved in the desired direction. Alternatively, the turnaround device may be mechanized using a motor or other power generating device to rotate the person on the platform. Brake 90 may be engaged (using brakes and methods of engaging brakes known in the art), while a person steps onto or off of the rotatable platform 80.

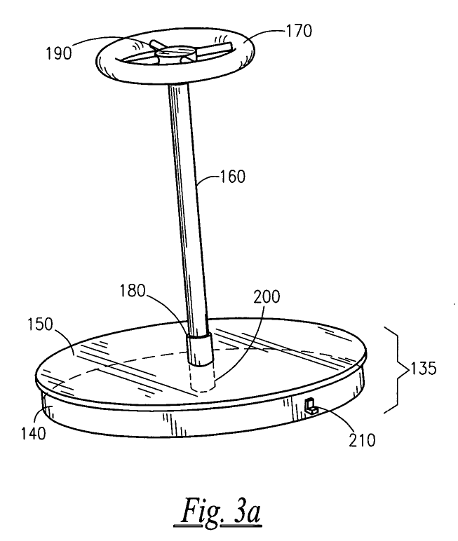

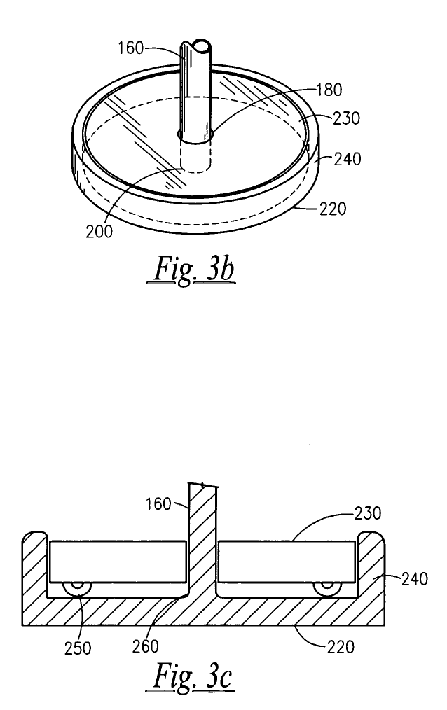

FIG. 3a depicts another embodiment of the present invention. As shown in the figure, the turnaround device includes a supporting device 135 having a stationary base 140 and a rotatable platform 150, a pole 160, and a handle 170 for a person to hold onto the pole. The base 140 and the rotatable platform 150 have coaxial vertical, central axes, and the rotatable platform 150 includes an opening 180 therethrough. The supporting device may be of a lazy Susan type in some embodiments. As depicted, the opening 180 has a vertical, central axis that is coaxial with that of the vertical, central axis of the rotatable platform 150. The pole 160 has a top end 190 and a bottom end 200. The pole 160 may be about three to about five feet in height and may be of a variety of diameters and cross-sections such that it is sufficiently strong to maintain the weight of a person that is pulling himself or herself to a standing position. The bottom end 200 of the pole 160 may be affixed to the stationary base 140 and may extend up through the opening 180 in the rotatable platform, such that a vertical, central axis of the pole is coaxial with that of the vertical, central axis of the stationary base 140. Handle 170 may be used to hold onto while a person is standing or sitting and may be fixedly or releasably attached to pole 160. Handle 170 may, for example, be a flat or spoked wheel that is affixed to the top end 190 of the pole 160 in a stationary, fixed position. In certain aspects, at least a portion of a plurality of rolling devices (i.e., bearings, among others known in the art) may contact the base 140 and the platform 150. The supporting device 135 may be a lazy Susan type assembly, as is known in the art. The turnaround device may include a braking device 210. Such braking devices 210 are known in the art. A person using such a turnaround device may step onto the rotatable platform 150, and he may then rotate himself on the platform 150 by spinning himself about the pole 160, while holding on until he reaches a desired position. Alternatively the walker may be mechanized using a motor or other power generating device to rotate the platform with the person on it. The brake 210 may be engaged, while a person steps onto or off of the rotatable platform 150. Furthermore, the supporting device 135 may be sufficiently large in diameter or properly weighted to prevent persons from toppling over as they pull themselves up into a standing position, and such physical parameters would be apparent to one skilled in the art. Persons wishing to pull themselves up to a standing position from, for example, a bed, may have part of the supporting device 135, depicted in FIG. 3a, slid under the bed. Thus, they may stand up on the platform 150 directly, without having to first stand up and then step up onto the platform 150.

In certain embodiments, the supporting device may have an alternative lazy Susan type assembly as depicted in FIG. 3b and cross-section 3c. In some embodiments, the rotatable platform 230 can be inset into the supporting device. A plurality of rolling devices may be between the rotatable platform 230 and the stationary base 220. In certain aspects, at least a portion of the rolling devices 250 contact the base 220 and the platform 230. The rolling devices 250 may be bearings or wheels, in some embodiments. An inset member 240 circumscribes the rotatable platform 230. A portion of the rotatable platform 230 or the top of the rotatable platform 230 may be coplanar with the top of the inset member 240.

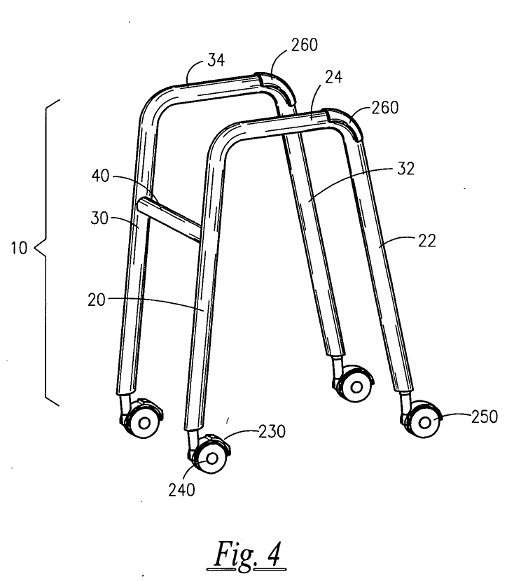

FIG. 4 depicts yet another possible embodiment of the present invention. FIG. 4 shows a turnaround device having a walker frame 10 having swiveling wheels 240 supporting the front legs 20, 30 of the frame 10, and at least one front wheel braking device 230, wherein each front wheel braking device 230 may engage a single front wheel 240. The walker frame 10 includes a left side member 20, 22, 24 and a right side member 30, 32, 34. The left and right side members each include a downwardly extending front leg 20, 30 and a downwardly extending rear leg 22, 32. The front and rear leg of each side member are connected through a frame member 24, 34. In the walker frame, the side members may be held rigidly spaced apart by at least one front frame member 40. Certain other walker frames known in the art may be used, as could be easily determined by one skilled in the art. By engaging and locking a front leg wheel braking device 230 on one of the front leg wheels 240 the walker frame 10 may be slid around on a walking surface, while pivoting about the braked wheel. Thus, allowing a person to turn around while using the walker. The braking device may be engaged by using a grip 260 on the walker frame. Alternatively, the braking device may be engaged by pushing down on the brake at the wheel directly, among other methods known in the art. In some embodiments, each rear leg 22, 32 is supported by wheels 250, and in other embodiments, the rear leg 22, 32 does not have a wheel 250, but instead employs a cap or button. In some embodiments, the turnaround device includes at least one rear wheel braking device, wherein each rear wheel braking device may engage a single rear wheel. The walker frame 10 may be slid around on a walking surface, while pivoting about a single rear leg braked wheel. Thus, allowing a person to turn around while using the walker. In some embodiments, the turnaround device may have two rear wheels with braking devices, and each rear wheel braking device may be engaged simultaneously. This causes the rear legs to behave similarly to legs having caps or buttons on the ends.

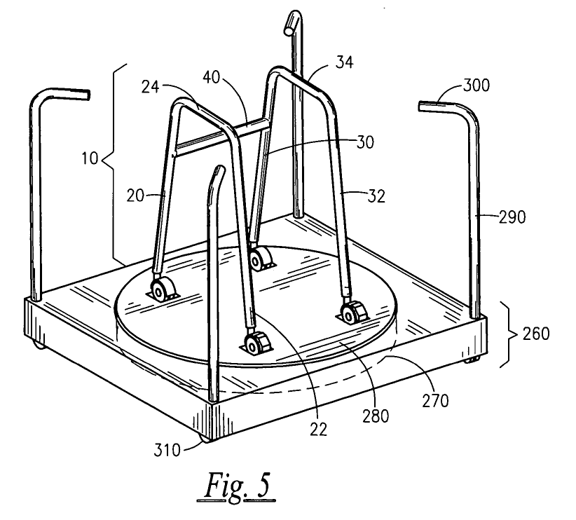

FIG. 5 depicts one embodiment of the present invention. The figure depicts a turnaround device having a walker frame 10. The walker frame 10 is as described above. Certain other walker frames known in the art may be used in the present invention. The turnaround device has a rotating structure for turning the walker frame 10 from a first position to a second position without a person having to lift the walker frame 10 between the first position and the second position. The rotating structure depicted in FIG. 5 includes a supporting device 260, which has a stationary base 270, a plurality of rolling devices, such as bearings, and a rotatable platform 280. The base 270 and the platform 280 may have coaxial vertical, central axes, and the rotatable platform 280 may rotate about its vertical central axis. In certain aspects, at least a portion of the rolling devices contact the base and the platform. The rolling devices may be bearings or wheels, in some embodiments. In some embodiments, the rotatable platform 280 may be inset into the stationary base 270. In certain embodiments, the supporting device may have at least one braking device. The supporting device 260 may be constructed as a lazy Susan type assembly, as is known in the art. The top of the supporting device 260 (e.g., rotatable platform 280) may secure the walker frame 10 to the supporting device 260, as described above. In some embodiments the structure employed to attach walker frame 10 to the supporting device 260 may be adjusted to releasably attach walker frame 10, in others the frame 10 may be permanently affixed to the supporting device 260. The stationary base 270 that may, in certain embodiments, contact a walking surface, and may have a plurality of poles 290 extending up perpendicular to the base 270. Each pole 290 may have a handle 300 attached to it. In certain embodiments, the handle 300 may be releasably adjusted to extend from the pole 290 or fold down to be parallel with the longitudinal axis of the pole 290. Persons using the turnaround device may step onto the rotatable platform 280 between two poles 290, then grasping the handles turn themselves to a desired position. Subsequently a person can step down from the turnaround device between two poles 290 or sit down in a chair, wheelchair, or other weight-bearing device. Alternatively, the turnaround device may be mechanized using a motor or other power generating device to rotate the person on the platform. A brake may be engaged (using brakes and methods of engaging brakes known in the art), while a person steps onto or off of the rotatable platform 280. In certain embodiments, the stationary base 270 may be supported by a plurality of wheels 310 that allow the turnaround device to be easily moved from place to place. As persons step onto the device, their weight pushing down may cause a braking system to engage the wheels 310.

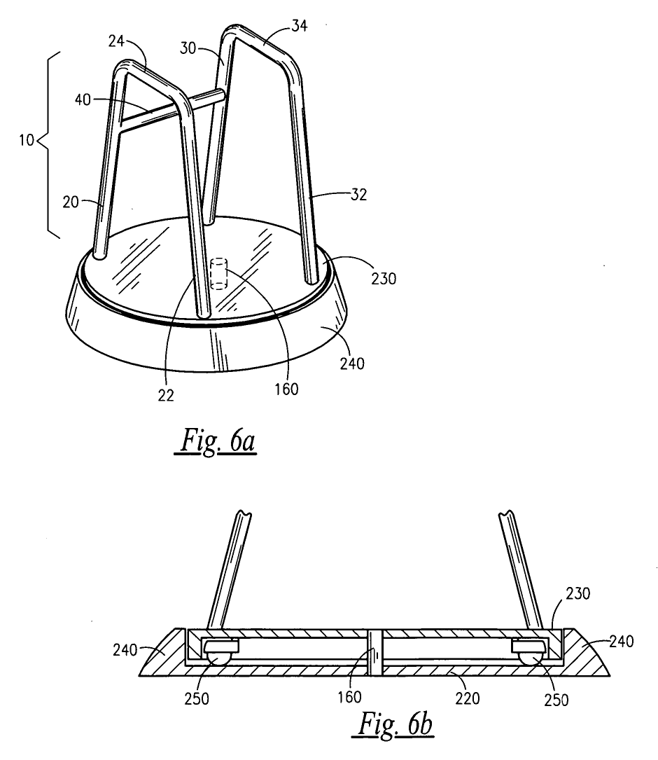

FIGS. 6a and 6b depict one embodiment of the present invention. The figures depict a turnaround device having a walker frame 10. The walker frame 10 is as described above. Certain other walker frames known in the art may be used in the present invention. The turnaround device depicted in FIGS. 6a and 6b has a rotating structure for turning the walker frame from a first position to a second position. The rotating structure depicted in FIGS. 6a and 6b includes a supporting device 160, 220, 230, 240, and 250 which has a stationary base 220, 240 that may, in certain embodiments, contact a walking surface, a plurality of rolling devices 250, an axle 160, and a rotatable platform 230. The rotatable platform 230 turns about an axle or axis 160. In certain aspects, at least a portion of the rolling devices 250 contact the base 220 and the platform 230. The supporting device 160, 220, 230, 240, and 250 may be constructed as a lazy Susan type assembly, as is known in the art. The top of the rotatable platform 230 may secure the walker frame 10, or the walker frame 10 may be permanently affixed to rotatable platform 230. In some embodiments, the device may include structures for securing the frame 10 to the top of the rotatable platform 230. A person using the turnaround device may step onto the rotatable platform 230, and a helper may then rotate the platform 230, so that the person on the device may be revolved in the desired direction. Alternatively, the turnaround device may be mechanized using a motor or other power generating device to rotate the person on the platform. In certain embodiments, a brake may be engaged (using brakes and methods of engaging brakes known in the art), while a person steps onto or off of the rotatable platform 230 or sits down in a chair, wheelchair, or other weight-bearing device.

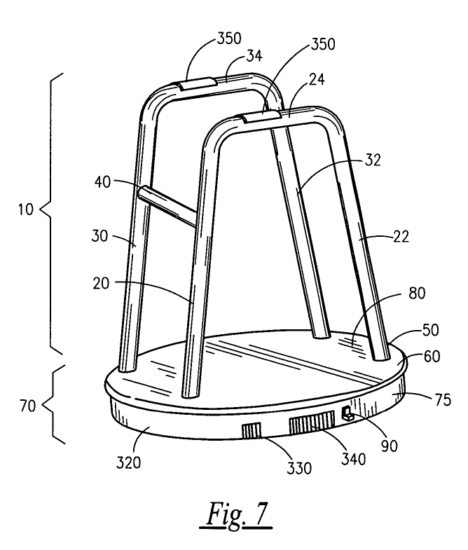

FIG. 7 depicts one embodiment of the present invention. The figures depict a turnaround device having a walker frame 10, as described above. The turnaround device depicted in FIG. 7 includes a supporting device 70, which has a stationary base 75 that may, in certain embodiments, contact a walking surface, a plurality of rolling devices and a rotatable platform 80. The base 75 and the platform 80 may have coaxial vertical, central axes, and the rotatable platform 80 may rotate about its vertical central axis. In certain aspects, at least a portion of the rolling devices contact the base and the platform. The rolling devices may be bearings or wheels in some embodiments. In certain embodiments, the supporting device may have at least one braking device 90. The supporting device 70 may be constructed as a lazy Susan type assembly, as is known in the art. The turnaround device may be mechanized using a motor or other power generating device to rotate the person on the platform. In certain embodiments, a rechargeable battery 330 can be part of the base 70 to allow cordless operation. Alternatively or additionally, an AC cord may be permanently or releasably attached at 340 to the base 70 to permit mechanized turning of the rotatable platform 80. One or more directional switches 350 may, in certain embodiments, be accessible to a person using the device at the top of the walker. The directional switch(es) 350 can permit a person to choose the direction in which they turn using the mechanized turnaround device. Brake 90 may be engaged using brakes and methods of engaging brakes known in the art, while a person steps onto or off of the rotatable platform 80.

While the invention has been described in detail and with reference to specific examples and figures thereof, it will be apparent to one skilled in the art that various changes and modifications may be made therein without departing from the spirit and scope thereof.

What is claimed is:

1. A turnaround device comprising,
a walker frame comprising a left side member and a right side member, the left and right side members each comprising a downwardly extending front leg and a downwardly extending rear leg, the side members held rigidly spaced apart by at least one front frame member; and
a rotating structure for turning the walker frame from a first position to a second position without a person having to lift the walker frame between the first position and the second position.

2. The turnaround device of claim 1, wherein the rotating structure is a supporting device.

3. The turnaround device of claim 2, wherein the supporting device comprises at least three wheels that contact a walking surface and a rotatable platform that is supported by the wheels.

4. The turnaround device of claim 3, wherein the supporting device further comprises at least one braking device.

5. The turnaround device of claim 2, wherein the supporting device comprises securing structures for securing the walker frame to the supporting device.

6. The turnaround device of claim 5, wherein the securing structures are adjustable to reversibly release the walker frame.

7. The turnaround device of claim 2, wherein the walker frame is permanently affixed to the supporting device.

8. The turnaround device of claim 2, wherein the supporting device comprises a stationary base, a plurality of rolling devices, and a rotatable platform above the stationary base, wherein the base and the rotatable platform have coaxial axes, the rotatable platform is rotatable about its axis, and at least one of the plurality of rolling devices contacts the base and the platform.

9. The turnaround device of claim 8, wherein the rolling devices are bearings.

10. The turnaround device of claim 8, wherein the supporting device further comprises at least one braking device.

11. A turnaround device comprising,
a supporting device comprising a stationary base and a rotatable platform above the stationary base, wherein (a) the base and the rotatable platform have coaxial axes, and (b) the rotatable platform comprises an opening therethrough, wherein the opening has an axis that is coaxial with that of the axis of the rotatable platform,
a pole having a top end and a bottom end, wherein the bottom end is affixed to the stationary base and extends up through the opening in the rotatable platform, such that an axis of the pole is coaxial with that of the axis of the stationary base, and
a handle attached to the pole.

12. The turnaround device of claim 11, wherein the supporting device further comprises a plurality of bearings that contact both the stationary base and the rotatable platform.

13. The turnaround device of claim 11, further comprising at least one braking device.

14. A turnaround device comprising,
a walker frame comprising a left side member and a right side member, the left and right side members each comprising a downwardly extending front leg and a downwardly extending rear leg, the side members held rigidly spaced apart by at least one front frame member, wherein each front leg is supported by a wheel; and
at least one front wheel braking device, wherein each front wheel braking device engages a wheel.

15. The turnaround device of claim 14, wherein each rear leg is supported by a wheel.

16. The turnaround device of claim 15, comprising at least one rear wheel braking device, wherein each rear wheel braking device engages at least one wheel.

17. The turnaround device of claim 16, comprising two rear wheel braking devices, wherein each rear wheel braking device is engaged simultaneously.

18. A turnaround device comprising,
a walker frame comprising a left side member and a right side member, the left and right side members each comprising a downwardly extending front leg and a downwardly extending rear leg, the side members held rigidly spaced apart by at least one front frame member; and
a supporting device for turning the walker frame from a first position to a second position without a person having to lift the walker frame between the first position and the second position, wherein the supporting device comprises a stationary base, a plurality of rolling devices, and a rotatable platform above the stationary base, wherein the base and the rotatable platform have coaxial axes, the rotatable platform rotates about its axis, and at least one of the plurality of rolling devices contacts the base and the platform.

19. The turnaround device of claim 18, further comprising a plurality of poles affixed and substantially perpendicular to the stationary base, wherein each pole comprises a handle.

20. The turnaround device of claim 18, wherein the turnaround device is mechanized.

21. The turnaround device of claim 20, wherein the turnaround device is mechanized using a rechargeable battery.

22. The turnaround device of claim 20, wherein the turnaround device comprises an electrical cord that is plugged into a power source.

23. The turnaround device of claim 20, wherein the turnaround device comprises directional switches.

24. A turnaround device comprising,
a walker frame having at least one downwardly extending leg; and
a rotating structure for turning the walker frame from a first position to a second position, without a person having to lift the walker frame between the first position and the second position.
